(19) United States
(12) Patent Application Publication
(10) Pub. No.: US 2012/0164397 A1
(43) Pub. Date: Jun. 28, 2012

(54) Barrier and a method for making a barrier

(76) Inventor: Brad DeOrnellas, Brighton, MI (US)

(21) Appl. No.: 12/930,068

(22) Filed: Dec. 27, 2010

(51) Int. Cl. B29C 65/00; B32B 3/12

(52) U.S. Cl. 428/195.1; 156/192

(57) ABSTRACT

A methodology 10 which produces a roll 50 of material which may be cut and sized as desired to meet the diverse barrier needs of various users and which protects the users from rain, wind, and other elements.

### GENERAL BACKGROUND

1. Field Of The invention

The present invention generally relates to a barrier and a method for making a barrier and more particularly, to a barrier which may be placed in a roll and which thereafter may be selectively and fixedly deployed within a hunting setting and which is effective to shield and protect hunters, and to a method for making such a barrier.

2. Background of the Invention

Hunting is a very popular sport and oftentimes hunters (such a deer hunters) have a need to be positioned behind a barrier (usually gun in hand) waiting for the deer (or other animal) to arrive at &baited site. When the deer (or other animal arrives), the hunter emerges from behind the barrier and shoots the deer (or other animal). These barriers are often referred to as “blinds”. Non-limiting examples of such other animals include elk, turkey, and waterfowl.

While many types of blinds do exist, they are often constructed mostly of cloth which loses its structural integrity due to rain and provides little or no protection for the hunter from such rain or wind. Moreover, these blinds or barriers (it should be appreciated that the terms “blinds” and “barriers” are use each used throughout this Application to generally refer to anything which a hunter (or other individual) may be positioned behind in order to be selectively concealed), usually comprise a fixed structure (having a frame and fixed structural dimensions) which makes them difficult to deploy and carry and which limits their usefulness in many situations. By way of example and without limitation, these fixed sized structures may not adequately shield a large individual or a number of individuals and are not structurally “tailorable” (are not capable of readily having their respective structural dimensions altered) to the diverse needs of the users. By way of a further example and without limitation, the respective structures may be too big to fit within a desired small clearing space or may be too small and readily apparent to animals if they are placed within a large open expanse.

The present inventions overcome these and other drawbacks of the current and prior strategies and provide a new and novel strategy.

### SUMMARY OF THE INVENTION

According to a first non-limiting object of the present inventions, a barrier is provided which overcomes some or all of the various previously delineated drawbacks of current and prior barriers.

According to a second non-limiting object of the present inventions, a method for creating a barrier is provided which allows the barrier to overcome some or all of the various previously delineated drawbacks of current and prior barriers.

According to a third non-limiting object of the present inventions, a selectively configurable barrier is provided.

According to a first non-limiting aspect of the present inventions, a barrier is provided and includes a thermoplastic base: and a printed veil residing upon said thermoplastic base.

According to a second non-limiting aspect of the present inventions, a barrier is provided and is made by the process of initially obtaining a veil; placing a pattern on the obtained veil: obtaining thermoplastic material; and attaching the veil to the thermoplastic material.

According to a third non-limiting aspect of the present inventions, a method for making a hunting barrier is provided and includes the steps of obtaining a veil; placing a design upon the veil; obtaining thermoplastic material; and attaching the veil to the thermoplastic material: and rolling the thermoplastic material into a roll.

These and other features, aspects, and advantages of the present inventions will become apparent from a reading of the following detailed description of the preferred embodiment of the inventions, including the subjoined claims, and by reference to the following drawings.

### BRIEF DESCRIPTION OF THE DRAWINGS

FIG. 1 is a flowchart illustrating the sequence of operational steps which cooperatively comprise the methodology of the preferred embodiment of the various inventions.

FIG. 2 is a perspective view of a barrier which is made in accordance with the teachings of the preferred embodiment of the invention and which is selectively deployed upon a pair of trees.

FIG. 3 is a side view of a barrier which is made in accordance with the teachings of the preferred embodiment of the invention and which is created in the form of a roll and which may be later selectively sized and cut in a desired manner.

FIG. 4 is a side view of a veil which is used in the methodology of FIG. 1.

FIG. 5 is a side view of a sheet of thermoplastic material which is used in the methodology of FIG. 1.

FIG. 6 is a side perspective view of a sheet of honeycomb material which is utilized by the methodology of FIG. 1.

FIG. 7 is a side perspective view of a barrier 91 which is made in accordance with the teachings of an alternate embodiment of the various inventions.

FIG. 8 is a side perspective view of a barrier which is made in accordance with the teachings of the preferred embodiment of the various inventions.

### DETAILED DESCRIPTION OF THE PREFERRED EMBODIMENT OF THE INVENTION

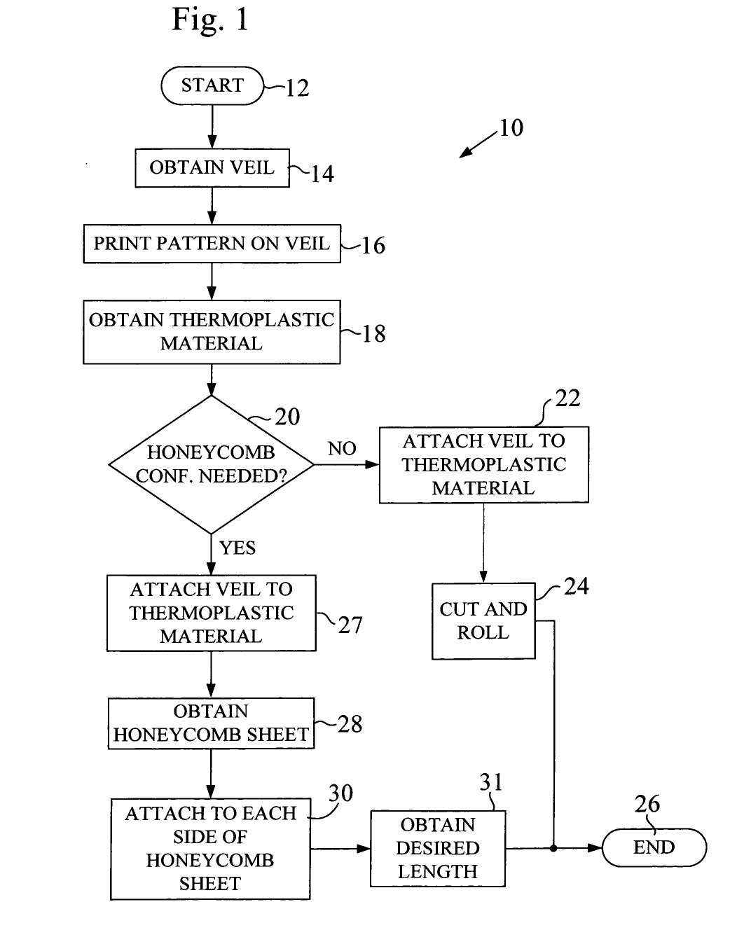

Referring now to FIG. 1, there is shown a methodology 10 which comprises the methodology of creating barriers according to the preferred embodiment of the inventions.

Methodology 10 begins with step 12 in which it is determined to create a barrier. Step 12 is followed by step 14 in which a relatively thin veil (see, for example the veil 15 which is shown in FIG. 4) of material is obtained. In one non-limiting embodiment, the veil comprises polyester material, although other materials may be utilized. Further, in one non-limiting embodiment the veil 15 may have a width 9 of about 1/32 of an inch to about 1/16 of an inch, although other widths may be used and may have a generally rectangular shape, although other shapes may be used. Veil 15 has two opposed broad surfaces 2, 5.

Step 16 follows step 14 and, in this step 16, a pattern 3 is printed on the veil 15. The pattern may be printed on the veil by the use of a sub-limination printing process or by any other known processes. One such process is employed by Penn Printing of South Carolina. In one non-limiting embodiment of the inventions, the pattern 3 comprises a traditional camouflage pattern, although other patterns may be utilized. Step 18 follows step 16 and, in this step 18, thermoplastic material is obtained (see, for example the sheet of thermoplastic material 19 of FIG. 5). In one non-limiting embodiment of the inventions, the sheet of thermoplastic material 19 has two large and opposed side surfaces 17, 21 and is generally rectangular in shape, although other shapes may be utilized. In one non-limiting embodiment of the various inventions, the width 23 of the sheet 19 may vary from about 1/10 to about ¼ of an inch, although other widths may be utilized. One non-limiting example of such a thermoplastic material is a fiberglass reinforced plastic material provided by Polystrand Corporation of Monroe, Colo.

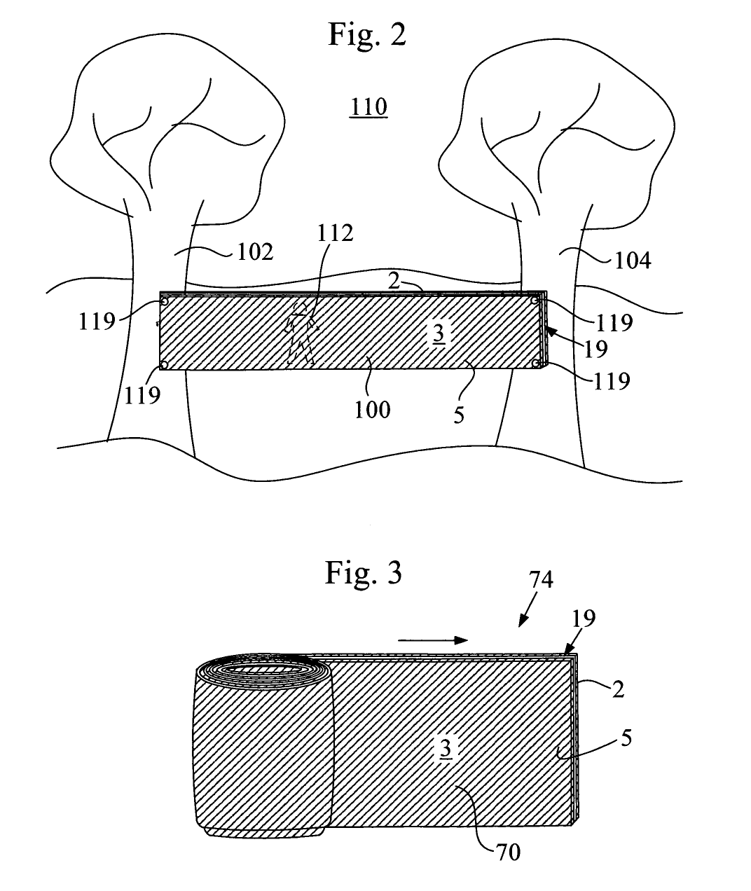

Step 18 is followed by step 20 in which it is determined whether a honeycombed configuration is needed. If no such honeycombed configuration is needed, then step 20 is followed by step 22. In step 22 a veil, such as a veil 15, is attached to each side 17, 21 of the thermoplastic material sheet 19 and such attachment may be made by the use of the use of a heat press apparatus, thereby producing a barrier 70 having a width 71, which is shown in FIG. 8. Step 24 follows step 22 and in step 24 the veil containing thermoplastic barrier 70 is cut to a desired length and width and then rolled into a roll 74, which is best shown in FIG. 3. Step 24 is followed by the step 26 which denotes the end of the methodology 10. One non-limiting example of such a honeycomb material is that provided by Plascore Corporation of Zeeland, Mich.

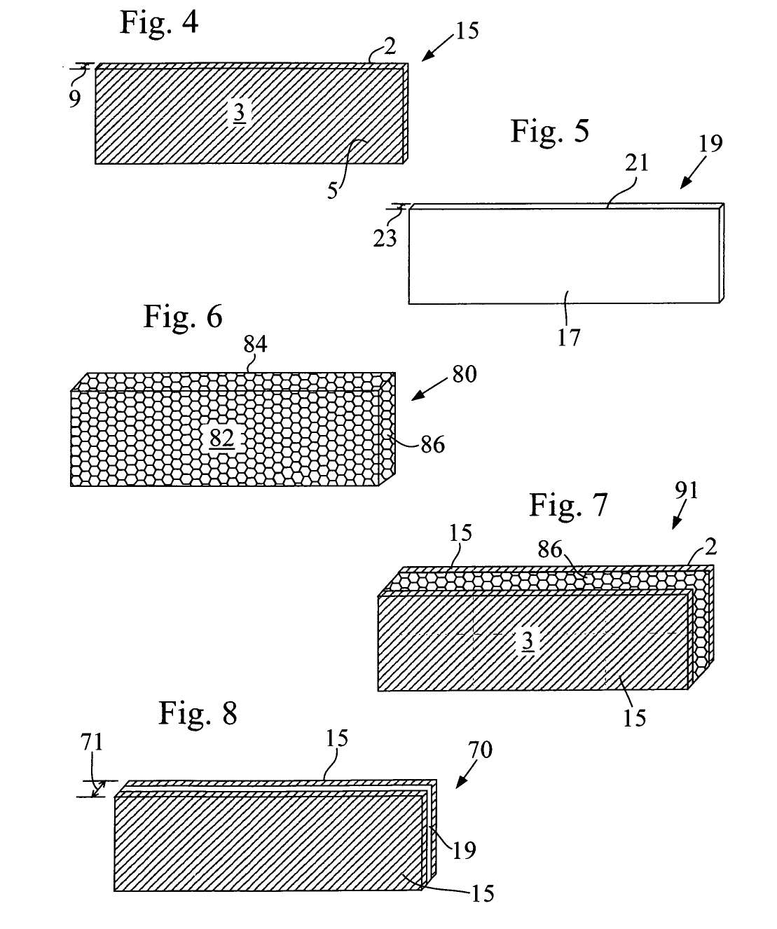

Alternatively, step 20 is followed by step 27 in which the veil 15 is attached to each side of the material sheet 19, such as in step 22. Step 28 following 27 in which a honeycomb sheet 80 (one example of which is shown in FIG. 6) is obtained. In one non-limiting embodiment, the honeycombed sheet 80 is commercially available and is manufactured from thermoplastic material. The sheet 80 has two opposed and large or broad surfaces 82, 84 which are integrally formed with and separated by a honeycombed interior 86. Step 28 is followed by step 30 in which veil 15 is attached to each opposed large side surface 82, 84 of the sheet, thereby forming a barrier 91 (best shown in FIG. 7). Step 30 is then followed by step 31 in which the barrier 91 is cut and sized as desired, and step 31 is followed by step 26. Alternatively, step 31 may be followed by step 24.

As is shown best in FIG. 3, at the conclusion of a first aspect of the methodology 10 a roll 74 of the barrier 70 is created and this roll 74 may be cut and sized as need for a particular application. That is, as shown best in FIG. 2, the roll 74 may be cut such that a sheet 100 is obtained and placed upon a pair of trees 102, 104 located in a field 110. The user or hunter 112 may then stand or otherwise be positioned behind the sheet 100 and the sheet 100 protects the user from wind, rain and other elements and hides the user or hunter 112. The ability to size the sheet 100 as needed provides great utility to the user. The sheet 100 may be fastened to the trees 102, 104 by the use of conventional fasteners 119, such as nails, screws, and/or rope. The honeycomb barrier 91 may be used in applications requiring additional protection and polyurea may be added to the various surfaces of each barrier 91, 100 to add blast and ballistic mitigation properties to these barriers 91, 100.

It should be appreciated that the present inventions are not limited to that which has been delineated above but that various changes may be made to the disclosed inventions without departing from the spirit and the scope of the inventions as they are more fully delineated in the following claims.

What is claimed is:

1. A barrier comprising a thermoplastic base: and a printed veil residing upon said thermoplastic base.

2. The barrier of claim 1 wherein said veil is constructed from polyester material.

3. A barrier made by the process of initially obtaining a veil; placing a pattern on said obtained veil: obtaining thermoplastic material; and attaching said veil to said thermoplastic material.

4. A method for making a hunting barrier comprising the steps of obtaining a veil; placing a design upon said veil; obtaining thermoplastic material; and attaching said veil to said thermoplastic material: and rolling said thermoplastic material into a roll.
